(19) United States
(12) Patent Application Publication
(10) Pub. No.: US 2023/0338765 A1
(43) Pub. Date: Oct. 26, 2023

(54) DEVICE TO ADJUST ELECTRONIC SPRINKLER TRIGGER

(71) Applicant: Tyco Fire Products LP, Lansdale, PA (US)

(72) Inventor: Cassandra Lyn DeNunzio, Cranston, RI (US)

(73) Assignee: Tyco Fire Products LP, Lansdale, PA (US)

(21) Appl. No.: 18/004,213

(22) PCT Filed: Sep. 9, 2021
(86) PCT No.: PCT/IB2021/058215

§ 371 Date: Jan. 4, 2023

Related U.S. Application Data
(60) Provisional application No. 63/077,212, filed on Sep. 11, 2020.

(51) Int. Cl. A62C 37/40; A62C 37/36; A62C 37/46

(52) U.S. Cl. CPC A62C 37/40; A62C 37/04; A62C 37/46

(57) ABSTRACT

A trigger device can include a sensor that detects a parameter corresponding to a fire condition, a comparator that evaluates the parameter to determine that the fire condition is present, a power source, and a trigger that receives power from the power supply and provides a control signal using the power to a control interface of a sprinkler responsive to the comparator determining that the fire condition is present to trigger operation of the sprinkler.

### CROSS-REFERENCE TO RELATED APPLICATIONS

The present application claims the benefit of priority to U.S. Provisional Application No. 63/077,212, filed Sep. 11, 2020, the disclosure of which is incorporated herein by reference in its entirety.

### BACKGROUND

Electronically activated sprinklers can be used to address fire conditions. For example, electronic sprinklers can receive a trigger signal and allow fluid to flow to address the fire condition responsive to the trigger signal.

### SUMMARY

At least one aspect relates to a trigger device. The trigger device can include a sensor that detects a parameter corresponding to a fire condition, a comparator that evaluates the parameter to determine that the fire condition is present, a power source, and a trigger that receives power from the power supply and provides a control signal using the power to a control interface of a sprinkler responsive to the comparator determining that the fire condition is present to trigger operation of the sprinkler.

At least one aspect relates to a sprinkler system. The sprinkler system can include an electronically activated sprinkler that changes from a first state preventing fluid flow through the sprinkler to a second state allowing fluid flow through the sprinkler responsive to a control signal and a trigger device. The trigger device can include a sensor that detects a parameter corresponding to a fire condition, a comparator that evaluates the parameter to determine that the fire condition is present, a power source, and a trigger that receives power from the power supply and provides the control signal using the power to the sprinkler responsive to the comparator determining that the fire condition is present.

At least one aspect relates to a method. The method can include disconnecting a sprinkler from a controller, connecting a trigger device with the sprinkler, detecting a fire condition using the trigger device, and causing operation of the sprinkler using the trigger device responsive to detecting the fire condition.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a sprinkler system.

FIG. 2 is a schematic diagram of an example of a trigger device.

FIG. 3 is a flow diagram of an example of a method of operating a sprinkler.

FIG. 4 is a schematic diagram of an example of an electronically activated sprinkler.

### DETAILED DESCRIPTION

Following below are more detailed descriptions of various concepts related to, and implementations of sprinkler systems and methods. Fire sprinklers can be used to address fire conditions by outputting fire suppression agents, such as water or other fire suppression fluids, to address the fire. The fire sprinklers (or the fire suppression agent delivered to the fire sprinklers) can be controlled to selectively output fire suppression agents. The various concepts introduced above and discussed in greater detail below can be implemented in any of numerous ways, including in sprinkler installation and retrofitting operations.

Fire suppression systems can use electronically activated fire sprinklers (EASs). For example, the EAS can include an electronically actuatable trigger that can change the sprinkler from a closed state to an open state responsive to a control signal. The control signal can be received from a fire control panel or other controller, which may generate and transmit the control signal responsive to a fire detection signal from a fire detector.

Making changes, such as upgrades or retrofits, to the fire suppression system or other systems in a building coupled with the fire suppression can require deactivating the fire suppression system. For example, such changes may require interaction with both electrical and water (e.g., piping, plumbing) systems. This can result in downtime for the fire suppression system during the modification to the system.

Systems and methods in accordance with the present disclosure can use a device (e.g., trigger device) that connects with an EAS to trigger the EAS, enabling the EASs in the fire suppression system to remain operational even if other components are not in a deactivated state. For example, the trigger device can include a sensor that detects a parameter corresponding to a fire condition, a comparator that evaluates the parameter to determine that the fire condition is present, a power source, and a trigger that receives power from the power supply and provides a control signal using the power to a control interface of a sprinkler responsive to the comparator determining that the fire condition is present to trigger operation of the sprinkler.

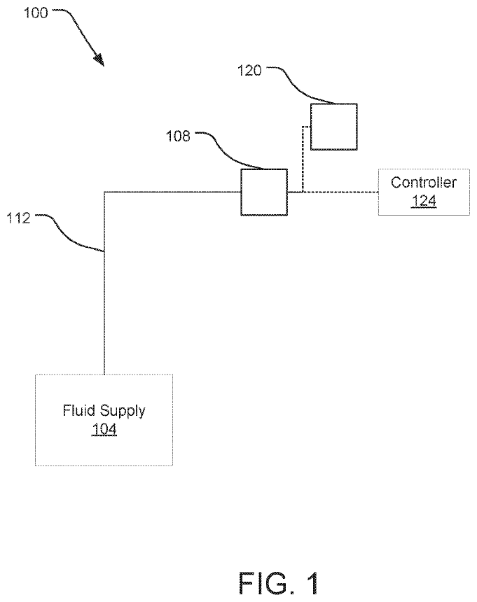

FIG. 1 depicts a sprinkler system 100. The sprinkler system 100 can include a fluid supply 104 coupled with one or more sprinklers 108 using one or more pipes 112. The sprinkler 108 can be actuated responsive to a fire condition, causing fluid to flow from the fluid supply 104 through the one or more pipes 112 and out of the sprinkler 108. The pipes 112 can extend through a building into a space between walls of the building. The sprinklers 108 can be EASs, which can enable the sprinklers 108 to be activated responsive to selected conditions, such as conditions indicative of a fire.

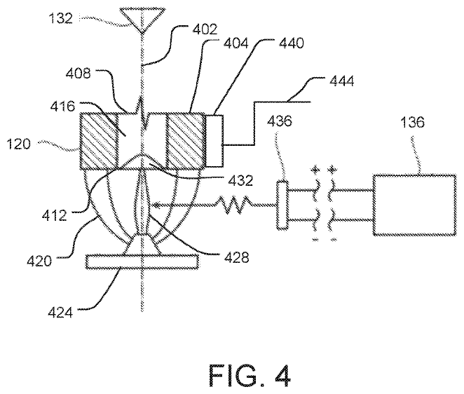

Referring briefly to FIG. 4, the sprinkler 108 can include a body 404 that defines an inlet 408 and an outlet 412. The inlet 408 can be coupled with the one or more pipes 112 to receive the fluid from the one or more pipes 112 and output the fluid through the outlet 412. The sprinkler 108 can include one or more frame arms 420 that extend away from the outlet 412 relative to the inlet 408 to a deflector 424. The deflector 424 can include one or more tines or other structures that deflect the fluid received from the outlet 412 according to a target spray pattern.

The sprinkler 108 can include a seal support 428, such as a frangible member (e.g., glass bulb), link, hook and strut, or other component that maintains a seal 432 in the outlet 412 to prevent the fluid from flowing out of the outlet 412. The seal support 428 can extend between the outlet 412 and the seal 432 towards the deflector 424 (e.g., to where the deflector 424 meets the frame arms 420). The sprinkler 108 can include or be coupled with a solenoid valve (not shown) that controls flow through the outlet 412 (e.g., for applications in which the sprinkler 108 is implemented as an open nozzle for which flow is controlled by operation of the solenoid valve, such as in response to a control signal from a fire control panel).

The sprinkler 108 can include or be coupled with an actuator 436. The actuator 436 can cause the seal support 428 to change from a first state in which the seal support 428 maintains the seal 432 in the outlet 412 (e.g., applies sufficient force against the seal 432 in a direction towards the inlet 408 to prevent pressure from fluid between the inlet 408 and the outlet 412 from moving the seal 432 out of the outlet 412) to a second state in which the seal support 428 does not maintain the seal 432 in the outlet 412. For example, the actuator 436 can break the seal support 428 or move the seal support 428 away from axis 402, allowing the seal 432 to be displaced so that fluid can flow out of the outlet 412. The actuator 436 can be a linear actuator or rotary actuator. The actuator 436 can control operation of the solenoid valve.

The actuator 436 can operate responsive to a control signal from a controller 124, which can be implemented by a fire control panel. The controller 124 can control operation of the solenoid valve (e.g., instead of using at least one of the seal support 428, the seal 432, and the actuator 436). The sprinkler 108 can include a control interface 440 that receives the control signal, such as through a wire 444 connected with the controller 124, and provides the control signal to the actuator 436 (or the solenoid valve) to control operation of the actuator 436.

Referring further to FIG. 1, the sprinkler system 100 can include at least one trigger device 120. The trigger device 120 can couple with the sprinkler 108 to enable operation of the sprinkler 108 independently from the controller 124. For example, the trigger device 120 can connect with the control interface 440 of the sprinkler 108 to cause operation of the sprinkler 108 while the sprinkler 108 is disconnected from the controller 124 (which would otherwise be used to cause operation of the sprinkler 108). Each sprinkler 108 can be connected with a respective trigger device 120. This can enable one or more sprinklers 108 to be selectively maintained in an operational state even if decoupled from the controller 124, such as during installation or retrofitting operations, in which the controller 124 or the wire 444 is disconnected.

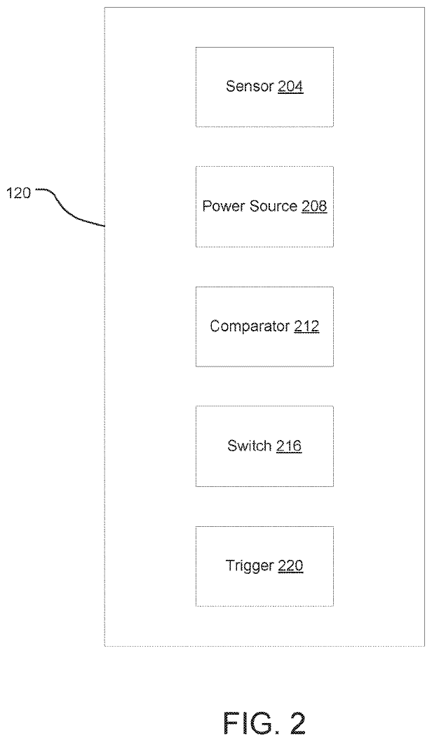

FIG. 2 depicts an example of the trigger device 120. The trigger device 120 or components thereof can be an electronic device, such as a printed circuit board, that connects with the control interface 440 of the sprinkler 108. The trigger device 120 can be used to enable the sprinkler 108 to continue to remain in an operational state even if other systems that interact with the sprinkler, such as electrical systems, are not operational, reducing downtime for a building. The trigger device 120 can be used to test operation of selected, individual sprinklers 108 without requiring all sprinklers 108 connected with a fire control panel or other control to be activated. For example, the trigger device 120 can receive an input at a user interface coupled with at least one of sensor 204, comparator 212, switch 216, and trigger 220 to indicate a test condition (e.g., provide a signal indicative of a fire condition to cause trigger 220 to activate the sprinkler 108).

The trigger device 120 can include at least one sensor 204. The sensor 204 can be used to detect at least one parameter indicative of a fire condition. For example, the sensor 204 can include at least one of a temperature sensor that detects a temperature of an environment around the trigger device 120 and a gas sensor (e.g., gas concentration sensor, smoke sensor) that detects at least one of a presence and a concentration of a gas in the environment.

The trigger device 120 can include at least one power source 208. The power source 208 can be a battery. The power source 208 can be an interface to a remote power supply. The power source 208 can be used to output an electrical signal to cause operation of the sprinkler 108.

The trigger device 120 can include a comparator 212 (e.g., comparator circuit). The comparator 212 can compare a value of the at least one parameter detected by the sensor 204 to a threshold value, such as to output an indication that the value exceeds the threshold value. For example, the comparator 212 can compare at least one of a temperature and a rate of rise of temperature detected by the sensor 204 to a corresponding threshold, and output an indication that the at least one of the temperature or the rate of rise of temperature exceeds the corresponding threshold. The comparator 212 can compare at least one of a concentration (or presence) of at least one gas and a rate of rise of the concentration of the at least one gas to one or more corresponding thresholds, and output an indication that the at least one of the concentration of the at least one gas and the rate of rise of the concentration of the at least one gas exceeds the corresponding threshold. Outputting the indication can include electrically connecting the power source 208 with trigger 220 described below (e.g., to cause an electrical signal to be provided to the sprinkler 108 to cause operation of the sprinkler 108). The thresholds can correspond to values that are indicative of a fire condition, such that the comparator 212 can be used to detect the fire condition. The comparator 212 can be coupled with a switch 216 to select the threshold(s) to be used for detecting the fire condition (e.g., to select the threshold temperature).

The trigger device 120 can include at least one trigger 220. The trigger 220 can output an electrical signal to the sprinkler 108 to cause operation of the sprinkler 108, such as to provide the electrical signal as the control signal to the control interface 440 of the sprinkler 108. The trigger 220 can be coupled with the at least one of the comparator 212 and the power source 208 to receive power from the power source 208 responsive to the comparator 212 detecting the fire condition. The trigger 220 can include one or more transistors, such as by including a transistor network.

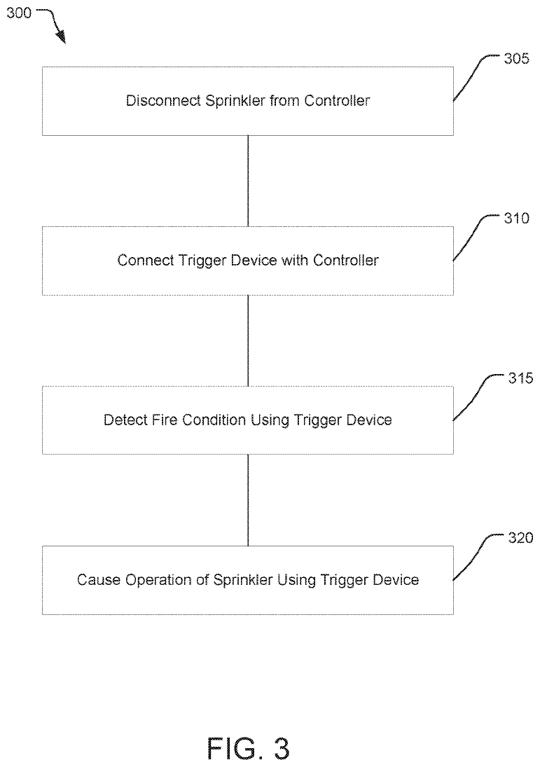

FIG. 3 depicts an example of a method 300 of operating a sprinkler. The method 300 can be performed using various systems and devices described herein, including the sprinkler system 100, the sprinkler 108, and the trigger device 120. The method 300 can be performed as part of an installation or retrofitting procedure for an electronic sprinkler system.

At 305, a sprinkler is disconnected from a controller. The sprinkler can be an EAS, such as by including or being coupled with an actuator that causes the sprinkler to change from a first state in which fluid flow through the sprinkler is prevented to a second state in which fluid flow through the sprinkler is allowed. The controller can be coupled with or implemented using a fire control panel. The controller can be coupled with a fire detector that detects a fire condition (e.g., based on temperature or gas concentration). The sprinkler can be disconnected from the controller to perform installation, retrofitting, or upgrades for a system that includes the sprinkler or various other fluid-based or electrical systems in a building that interact with the sprinkler. Disconnecting the sprinkler from the controller can include electrically disconnecting the sprinkler from the controller, such as by disconnecting a wire between the sprinkler and the controller, or discontinuing electrical current flow between the controller and the sprinkler.

At 310, a trigger device is connected with the sprinkler. The trigger device can be connected with the sprinkler by being electrically connected to an interface of the sprinkler that provides electrical power to an actuator, solenoid valve, or other component used to change the sprinkler from the first state to the second state.

At 315, the trigger device detects a fire condition. The trigger device can detect the fire condition responsive to at least one of a value of a parameter or a rate of change of the value of the parameter meeting or exceeding a corresponding threshold. For example, the trigger device can detect the fire condition based on detecting temperature, the presence of a gas, or the concentration of a gas that indicates a fire condition is present.

At 320, the trigger device causes operation of the sprinkler. For example, the trigger device can output a control signal responsive to detecting the fire condition that triggers operation of the sprinkler, such as to operate a solenoid valve of the sprinkler or operate an actuator of the sprinkler to unseal the sprinkler.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Computer program products are stored in a tangible form on non-transitory computer readable media and non-transitory physical hardware storage devices that are suitable for embodying computer program instructions and data. These include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory and other non-transitory devices.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced. Other substitutions, modifications, changes, and omissions may be made in the design, operating conditions and arrangement of embodiments without departing from the scope of the present disclosure.

As utilized herein, the terms “approximately,” “about,” “substantially”, and similar terms are intended to include any given ranges or numbers +/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A trigger device, comprising:
a sensor that detects a parameter corresponding to a fire condition;
a comparator that evaluates the parameter to determine that the fire condition is present;
a power source; and
a trigger that receives power from the power supply and provides a control signal using the power to a control interface of a sprinkler responsive to the comparator determining that the fire condition is present to trigger operation of the sprinkler.

2. The trigger device of claim 1, comprising:
a wire that connects the trigger to the control interface.

3. The trigger device of claim 1, comprising:
the trigger comprises at least one transistor.

4. The trigger device of claim 1, comprising:
a printed circuit board that comprises the comparator and the trigger.

5. The trigger device of claim 1, comprising:
the power source comprises at least one of a battery and an interface to a remote power supply.

6. The trigger device of claim 1, comprising:
the comparator determines that the fire condition is present responsive to a value of the parameter meeting or exceeding a threshold.

7. A sprinkler system, comprising:
an electronically activated sprinkler that changes from a first state preventing fluid flow through the sprinkler to a second state allowing fluid flow through the sprinkler responsive to a control signal; and
a trigger device, comprising:
a sensor that detects a parameter corresponding to a fire condition;
a comparator that evaluates the parameter to determine that the fire condition is present;
a power source; and
a trigger that receives power from the power source and provides the control signal using the power to the sprinkler responsive to the comparator determining that the fire condition is present.

8. The sprinkler system of claim 7, comprising:
a wire that connects the trigger with a control interface of the sprinkler.

9. The sprinkler system of claim 7, comprising:
the sprinkler includes an actuator that is triggered responsive to the control signal to change the sprinkler from the first state to the second state.

10. The sprinkler system of claim 7, comprising:
one or more pipes that connect the sprinkler with a fluid supply, the sprinkler is connected with the one or more pipes while connected with the trigger device.

11. The sprinkler system of claim 7, comprising:
a fire control panel that is disconnected from the sprinkler while the trigger device is connected with the sprinkler.

12. The sprinkler system of claim 7, comprising:
a wire that connects the trigger to the control interface.

13. The sprinkler system of claim 7, comprising:
the trigger comprises at least one transistor.

14. The sprinkler system of claim 7, comprising:
a printed circuit board that comprises the comparator and the trigger.

15. The sprinkler system of claim 7, comprising:
the power source comprises at least one of a battery and an interface to a remote power source.

16. The sprinkler system of claim 7, comprising:
the comparator determines that the fire condition is present responsive to a value of the parameter meeting or exceeding a threshold.

17. A method, comprising:
disconnecting a sprinkler from a controller;
connecting a trigger device with the sprinkler;
detecting a fire condition using the trigger device; and
causing operation of the sprinkler using the trigger device responsive to detecting the fire condition.

18. The method of claim 17, comprising:
causing operation of the sprinkler by providing a control signal to an actuator of the sprinkler.

19. The method of claim 17, comprising:
detecting the fire condition responsive to a parameter comprising at least one of a temperature, a presence of a gas, and a concentration of a gas.

20. The method of claim 17, comprising:
connecting the trigger device with a control interface of the sprinkler using a wire.
